(19) United States
(12) Patent Application Publication
(10) Pub. No.: US 2013/0057072 A1
(43) Pub. Date: Mar. 7, 2013

(54) UNINTERRUPTED POWER SUPPLY APPARATUS AND POWER-SUPPLYING METHOD FOR THE SAME

(71) Applicants: Wei-Chun WANG, Taoyuan County (TW); Chia-Hsiang LI, Taoyuan County (TW)

(72) Inventors: Wei-Chun WANG, Taoyuan County (TW); Chia-Hsiang LI, Taoyuan County (TW)

(73) Assignee: DELTA ELECTRONICS, INC., Taoyuan County (TW)

(21) Appl. No.: 13/523,146

(22) Filed: Jun. 14, 2012

(30) Foreign Application Priority Data
Sep. 7, 2011 (TW) 100132161

(51) Int. Cl. H02J 9/00

(52) U.S. Cl. 307/64

(57) ABSTRACT

An uninterrupted power supply apparatus is applied to an alternating current power apparatus and a load. The uninterrupted power supply apparatus includes a power distribution unit, a power supply unit, and an uninterrupted power supply unit. The power distribution unit includes a plurality of slots. The power distribution unit is electrically connected to the alternating current power apparatus and the load. The power supply unit is electrically connected to the power distribution unit and inserted into the corresponding slot. The uninterrupted power supply unit is electrically connected to the power distribution unit and inserted into the corresponding slot. The present invention is provided to improve the performance of the uninterrupted power supply and reduce occupied space of a cabinet to save space.

### BACKGROUND OF THE INVENTION

1. Field of the Invention

The present invention relates to a power supply apparatus and power-supplying method for the same, and especially relates to an uninterrupted power supply apparatus and power-supplying method for the same.

2. Description of Prior Art

Uninterrupted power supplies are used in a variety of applications to provide power to loads, for example, loads that are intended to operate during interruptions in a primary source of electrical power. In general, an uninterrupted power supply includes, or is connected to, both a primary source of electrical power and an alternate source of electrical power where the alternate source of electrical power can be employed to supply power to the loads when the primary source of electrical power is not available. Often, the primary source of electrical power is an alternating current power source such as power supplied from an electric utility. The alternate source of electrical power generally includes one or more batteries supplying direct current power.

FIG. 1 shows a block diagram of an application of conventional uninterrupted power supply. A power distribution unit 106 comprises a plurality of slots 108. At least a power supply unit 110 is electrically connected to the power distribution unit 106 and inserted into the corresponding slot 108. The power distribution unit 106 is electrically connected to an uninterrupted power supply unit 104 and a load 112. An alternating current power apparatus 102 is electrically connected to the uninterrupted power supply unit 104.

The disadvantages of the conventional uninterrupted power supply shown in the FIG. 1 are as following.

1. Two cabinets are required (one for the uninterrupted power supply unit 104, the other for the power distribution unit 106 and the power supply unit 110 inserted into the corresponding slot 108), so that the space is wasted.

2. The uninterrupted power supply needs to shut down when the uninterrupted power supply unit 104 is changed.

3. Extra layouts are required, so that the material and labor cost is higher but the efficiency of assembly is lower.

Then, there are products combining the uninterrupted power supply unit 104 and the power supply unit 110. FIG. 2 shows a block diagram of another application of conventional uninterrupted power supply. A power distribution unit 106 comprises a plurality of slots 108. At least a power supply and uninterrupted power supply unit 114 is electrically connected to the power distribution unit 106 and inserted into the corresponding slot 108. The power distribution unit 106 is electrically connected to an alternating current power apparatus 102 and a load 112.

Although only one cabinet is required for the conventional uninterrupted power supply shown in the FIG. 2 (the power distribution unit 106 and the power supply and uninterrupted power supply unit 114 inserted into the corresponding slot 108 share one cabinet), the efficiency is not good. The whole power of the power supply and uninterrupted power supply unit 114 cannot be raised because of the limited output power of the uninterrupted power supply part of the power supply and uninterrupted power supply unit 114.

Besides, the power supply and uninterrupted power supply unit 114 is combined with the power supply part and the uninterrupted power supply part, so the power of the uninterrupted power supply part cannot be changed flexibly. Moreover, the uninterrupted power supply needs to shut down and the whole power supply and uninterrupted power supply unit 114 needs to change when the power supply part or the uninterrupted power supply part of the power supply and uninterrupted power supply unit 114 fails.

### SUMMARY OF THE INVENTION

In order to solve the above-mentioned problems, an object of the present invention is to provide an uninterrupted power supply apparatus to improve the performance of the uninterrupted power supply and reduce occupied space of a cabinet to save space.

In order to solve the above-mentioned problems, another object of the present invention is to provide a power-supplying method for uninterrupted power supply apparatus to improve the performance of the uninterrupted power supply and reduce occupied space of a cabinet to save space.

In order to achieve the object of the present invention mentioned above, the uninterrupted power supply apparatus of the present invention is applied to an alternating current power apparatus and a load. The uninterrupted power supply apparatus includes a power distribution unit, a power supply unit, and an uninterrupted power supply unit. The power distribution unit includes a plurality of slots. The power distribution unit is electrically connected to the alternating current power apparatus and the load. The power supply unit is electrically connected to the power distribution unit and inserted into the corresponding slot. The uninterrupted power supply unit is electrically connected to the power distribution unit and inserted into the corresponding slot.

In order to achieve the other object of the present invention mentioned above, the power-supplying method for uninterrupted power supply apparatus of the present invention is applied to an alternating current power apparatus and a load. The power-supplying method for uninterrupted power supply apparatus comprises following steps. An alternating current power is sent from the alternating current power apparatus to a power distribution unit, wherein the power distribution unit is electrically connected to the load, and the power distribution unit includes a plurality of slots. A power supply unit is provided, wherein the power supply unit is electrically connected to the power distribution unit and inserted into the corresponding slot. An uninterrupted power supply unit is provided, wherein the uninterrupted power supply unit is electrically connected to the power distribution unit and inserted into the corresponding slot. The alternating current power is sent from the power distribution unit to the power supply unit through the slot after the alternating current power is received by the power distribution unit. The alternating current power is transformed to a direct current power by the power supply unit after the alternating current power is received by the power supply unit. The direct current power is sent from the power supply unit to the power distribution unit through the slot after the alternating current power is transformed to the direct current power by the power supply unit. The direct current power is sent from the power distribution unit to the uninterrupted power supply unit through the slot after the direct current power is received by the power distribution unit.

### BRIEF DESCRIPTION OF DRAWING

FIG. 1 shows a block diagram of an application of conventional uninterrupted power supply.

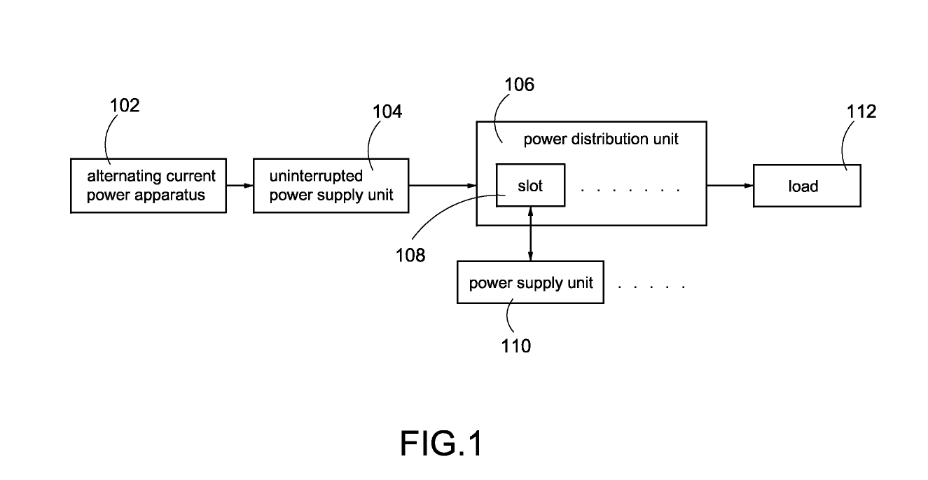

FIG. 2 shows a block diagram of another application of conventional uninterrupted power supply.

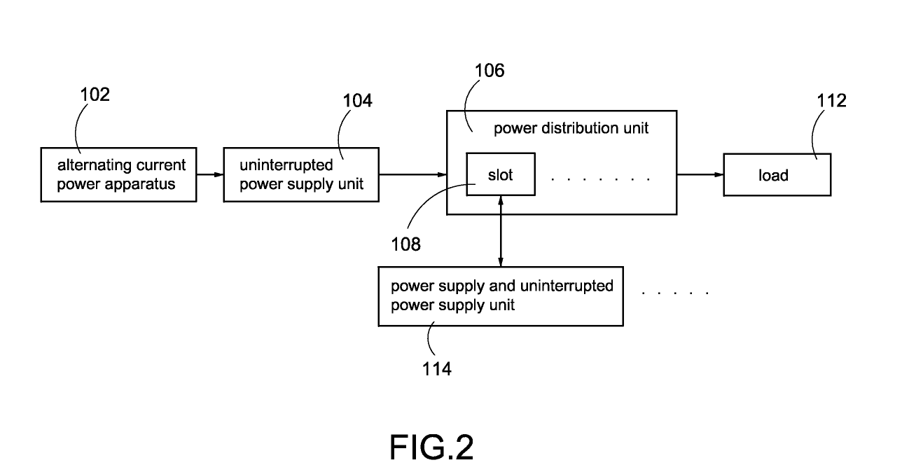

FIG. 3 shows a block diagram of the uninterrupted power supply apparatus of the present invention.

FIG. 4 shows a diagram of an application of the uninterrupted power supply apparatus of the present invention.

FIG. 5 shows a block diagram of an embodiment of the uninterrupted power supply apparatus of the present invention.

FIG. 6 shows a flow chart of an embodiment of the power-supplying method for uninterrupted power supply apparatus of the present invention.

FIG. 7 shows a flow chart of another embodiment of the power-supplying method for uninterrupted power supply apparatus of the present invention.

### DETAILED DESCRIPTION OF THE INVENTION

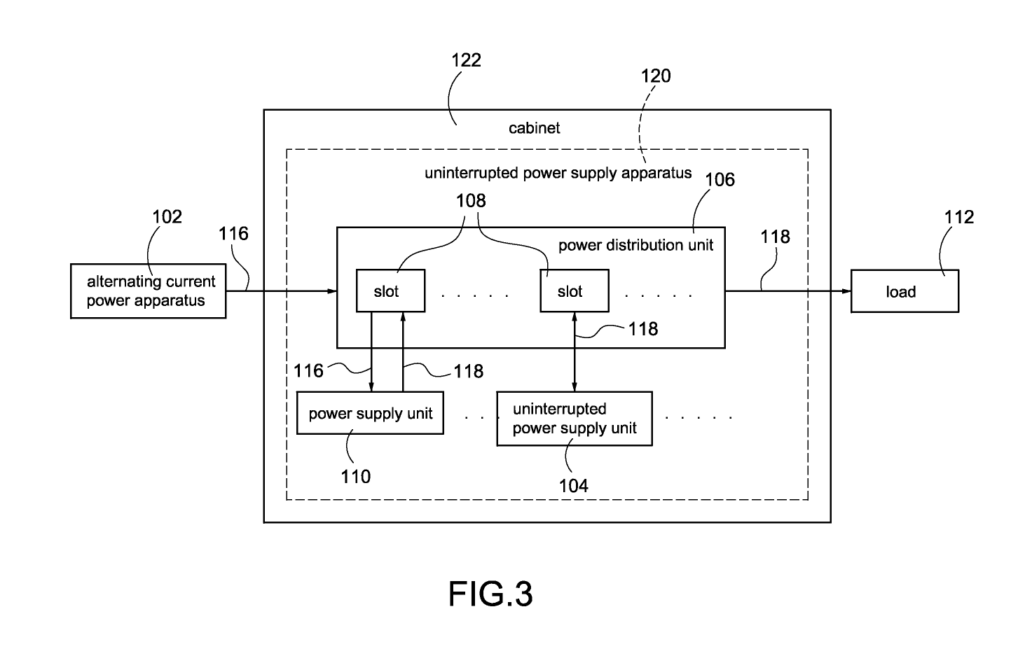

FIG. 3 shows a block diagram of the uninterrupted power supply apparatus of the present invention. An uninterrupted power supply apparatus 120 is applied to an alternating current power apparatus 102 and a load 112. The uninterrupted power supply apparatus 120 includes a power distribution unit 106, at least a power supply unit 110, and at least an uninterrupted power supply unit 104. The power distribution unit 106 includes a plurality of slots 108.

The power distribution unit 106 is electrically connected to the alternating current power apparatus 102 and the load 112. The power supply unit 110 is electrically connected to the power distribution unit 106 and inserted into the corresponding slot 108. The uninterrupted power supply unit 104 is electrically connected to the power distribution unit 106 and inserted into the corresponding slot 108.

In an embodiment, the uninterrupted power supply apparatus 120 includes a plurality of the power supply units 110, and a plurality of the uninterrupted power supply units 104. The uninterrupted power supply unit 104 is pluggable (namely, which can be inserted and pulled out of). The power supply unit 110 is pluggable. The uninterrupted power supply apparatus 120 is arranged in a cabinet 122.

When the alternating current power apparatus 102 is available, the charging route for the uninterrupted power supply unit 104 is as following.

1. An alternating current power 116 is sent from the alternating current power apparatus 102 to the power distribution unit 106.

2. The alternating current power 116 is sent from the power distribution unit 106 to the power supply unit 110 through the slot 108 after the alternating current power 116 is received by the power distribution unit 106.

3. The alternating current power 116 is transformed to a direct current power 118 by the power supply unit 110 after the alternating current power 116 is received by the power supply unit 110.

4. The direct current power 118 is sent from the power supply unit 110 to the power distribution unit 106 through the slot 108 after the alternating current power 116 is transformed to the direct current power 118 by the power supply unit 110.

5. The direct current power 118 is sent from the power distribution unit 106 to the uninterrupted power supply unit 104 through the slot 108 after the direct current power 118 is received by the power distribution unit 106. Therefore, the uninterrupted power supply unit 104 is charged.

When the alternating current power apparatus 102 is available, the charging route for the load 112 is as following.

1. The alternating current power 116 is sent from the alternating current power apparatus 102 to the power distribution unit 106.

2. The alternating current power 116 is sent from the power distribution unit 106 to the power supply unit 110 through the slot 108 after the alternating current power 116 is received by the power distribution unit 106.

3. The alternating current power 116 is transformed to a direct current power 118 by the power supply unit 110 after the alternating current power 116 is received by the power supply unit 110.

4. The direct current power 118 is sent from the power supply unit 110 to the power distribution unit 106 through the slot 108 after the alternating current power 116 is transformed to the direct current power 118 by the power supply unit 110.

5. The direct current power 118 is sent from the power distribution unit 106 to the load 112 after the direct current power 118 is received by the power distribution unit 106. Therefore, the load 112 is charged.

When the alternating current power apparatus 102 is not available, the load 112 is charged by the uninterrupted power supply unit 104 through the slot 108 and the power distribution unit 106.

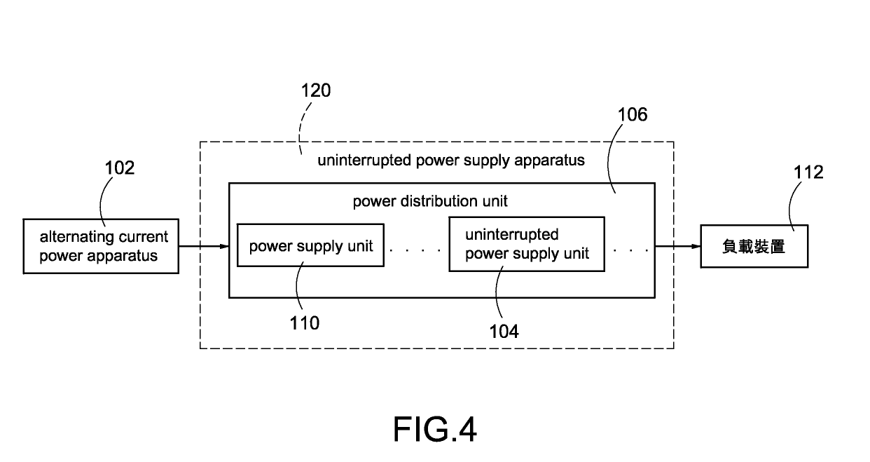

FIG. 4 shows a diagram of an application of the uninterrupted power supply apparatus of the present invention. The uninterrupted power supply units 104 and the power supply units 110 have been inserted into the corresponding slots 108.

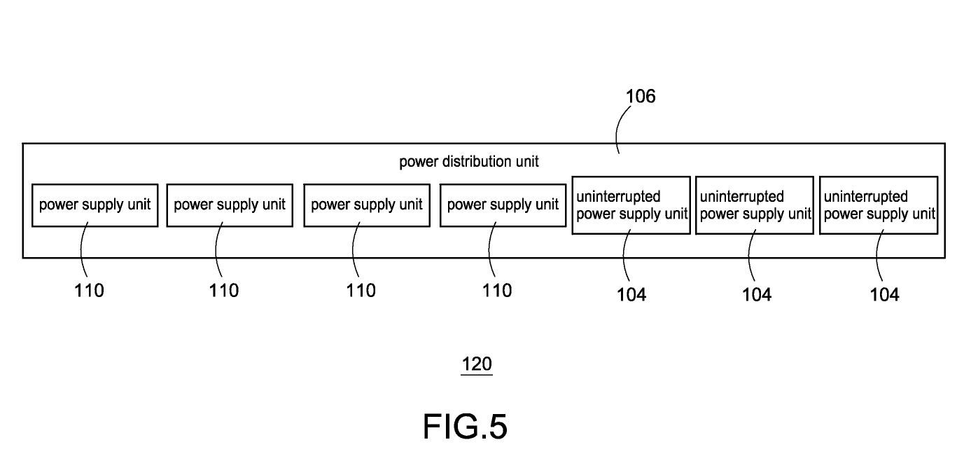

FIG. 5 shows a block diagram of an embodiment of the uninterrupted power supply apparatus of the present invention. The uninterrupted power supply apparatus 120 includes four power supply units 110, and three uninterrupted power supply units 104. FIG. 4 and FIG. 5 show only embodiments of the present invention. The quantities of the power supply unit 110 and the uninterrupted power supply unit 104 may be changed according to the requirement, while one-by-one correspondence between the power supply unit 110 and the uninterrupted power supply unit 104 is not necessary. Therefore, the power of the uninterrupted power supply apparatus 120 is flexible.

The uninterrupted power supply unit 104 and the power supply unit 110 are inserted into the corresponding slots 108 respectively to be electrically connected to the power distribution unit 106. When the alternating current power apparatus 102 is available, low voltage direct current power is supplied from the power supply unit 110 to the load 112. When the alternating current power apparatus 102 is not available, the load 112 is charged by the uninterrupted power supply unit 104.

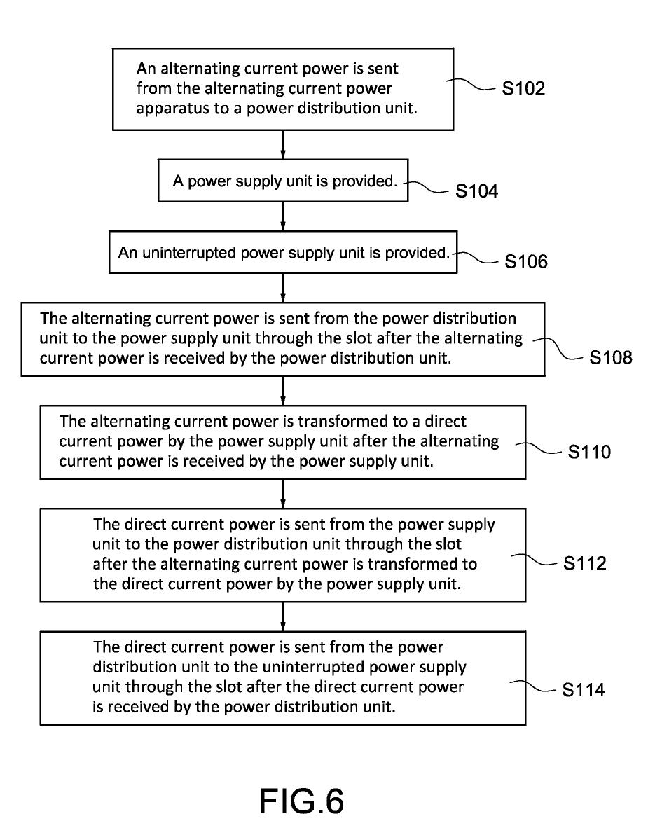

FIG. 6 shows a flow chart of an embodiment of the power-supplying method for uninterrupted power supply apparatus of the present invention. The power-supplying method for uninterrupted power supply apparatus of the present invention is applied to an alternating current power apparatus and a load. The power-supplying method for uninterrupted power supply apparatus comprises following steps.

S102: An alternating current power is sent from the alternating current power apparatus to a power distribution unit. The power distribution unit is electrically connected to the load, and the power distribution unit includes a plurality of slots.

S104: A power supply unit is provided. The power supply unit is electrically connected to the power distribution unit and inserted into the corresponding slot. In an embodiment, a plurality of the power supply units is provided. The power supply unit is pluggable.

S106: An uninterrupted power supply unit is provided. The uninterrupted power supply unit is electrically connected to the power distribution unit and inserted into the corresponding slot. In an embodiment, a plurality of the uninterrupted power supply units is provided. The uninterrupted power supply unit is pluggable.

The power distribution unit, the power supply unit inserted into the corresponding slot, and the uninterrupted power supply unit inserted into the corresponding slot are arranged in one cabinet.

S108: The alternating current power is sent from the power distribution unit to the power supply unit through the slot after the alternating current power is received by the power distribution unit.

S110: The alternating current power is transformed to a direct current power by the power supply unit after the alternating current power is received by the power supply unit.

S112: The direct current power is sent from the power supply unit to the power distribution unit through the slot after the alternating current power is transformed to the direct current power by the power supply unit.

S114: The direct current power is sent from the power distribution unit to the uninterrupted power supply unit through the slot after the direct current power is received by the power distribution unit. Therefore, the uninterrupted power supply unit 104 is charged.

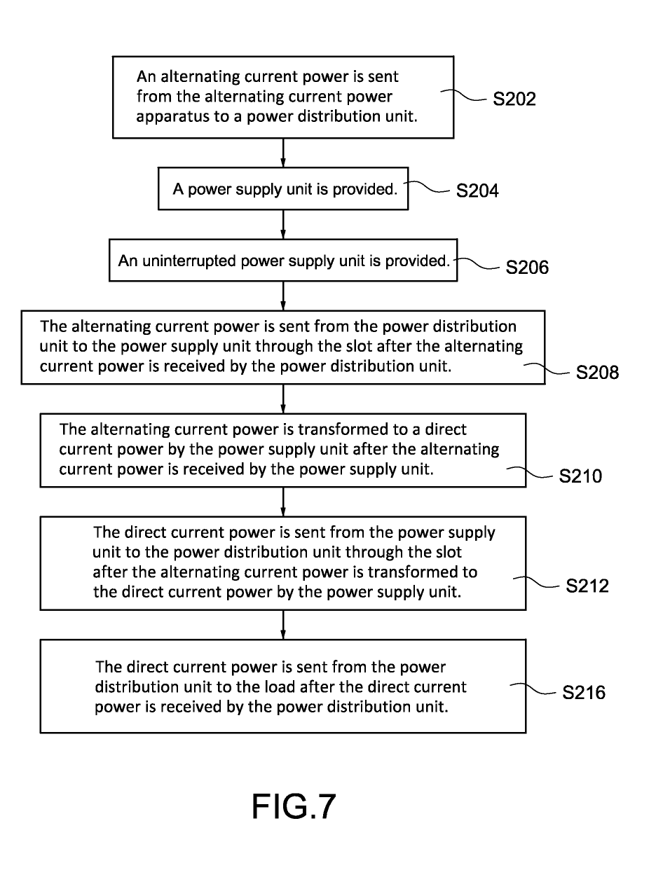

FIG. 7 shows a flow chart of another embodiment of the power-supplying method for uninterrupted power supply apparatus of the present invention. The power-supplying method for uninterrupted power supply apparatus of the present invention is applied to an alternating current power apparatus and a load. The power-supplying method for uninterrupted power supply apparatus comprises following steps.

S202: An alternating current power is sent from the alternating current power apparatus to a power distribution unit. The power distribution unit is electrically connected to the load, and the power distribution unit includes a plurality of slots.

S204: A power supply unit is provided. The power supply unit is electrically connected to the power distribution unit and inserted into the corresponding slot. In an embodiment, a plurality of the power supply units is provided. The power supply unit is pluggable.

S206: An uninterrupted power supply unit is provided. The uninterrupted power supply unit is electrically connected to the power distribution unit and inserted into the corresponding slot. In an embodiment, a plurality of the uninterrupted power supply units is provided. The uninterrupted power supply unit is pluggable.

The power distribution unit, the power supply unit inserted into the corresponding slot, and the uninterrupted power supply unit inserted into the corresponding slot are arranged in one cabinet.

S208: The alternating current power is sent from the power distribution unit to the power supply unit through the slot after the alternating current power is received by the power distribution unit.

S210: The alternating current power is transformed to a direct current power by the power supply unit after the alternating current power is received by the power supply unit.

S212: The direct current power is sent from the power supply unit to the power distribution unit through the slot after the alternating current power is transformed to the direct current power by the power supply unit.

S216: The direct current power is sent from the power distribution unit to the load after the direct current power is received by the power distribution unit. Therefore, the load is charged.

When the alternating current power apparatus is not available, the load is charged by the uninterrupted power supply unit through the slot and the power distribution unit.

The advantages of the present invention are as following.

1. The circuit is simple.

2. Only one cabinet is required, so that the space is saved.

3. Extra layouts are not required, so that the material and labor cost is lower and the efficiency of assembly is higher.

4. The quantities of the power supply unit and the uninterrupted power supply unit are adjustable according to the requirement.

5. If one of the uninterrupted power supply units fails, just changes the failure uninterrupted power supply unit, and the uninterrupted power supply apparatus is not required to shut down.

6. The power of the uninterrupted power supply unit can be changed flexibly.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An uninterrupted power supply apparatus applied to an alternating current power apparatus and a load, the uninterrupted power supply apparatus including:
a power distribution unit electrically connected to the alternating current power apparatus and the load, the power distribution unit including a plurality of slots;
a power supply unit electrically connected to the power distribution unit and inserted into the corresponding slot; and
an uninterrupted power supply unit electrically connected to the power distribution unit and inserted into the corresponding slot.

2. The uninterrupted power supply apparatus in claim 1, wherein an alternating current power is sent from the alternating current power apparatus to the power distribution unit.

3. The uninterrupted power supply apparatus in claim 2, wherein the alternating current power is sent from the power distribution unit to the power supply unit through the slot after the alternating current power is received by the power distribution unit.

4. The uninterrupted power supply apparatus in claim 3, wherein the alternating current power is transformed to a direct current power by the power supply unit

5. The uninterrupted power supply apparatus in claim 4, wherein the direct current power is sent from the power supply unit to the power distribution unit through the slot.

6. The uninterrupted power supply apparatus in claim 5, wherein the direct current power is sent from the power distribution unit to the uninterrupted power supply unit through the slot.

7. The uninterrupted power supply apparatus in claim 6, wherein the direct current power is sent from the power distribution unit to the load.

8. The uninterrupted power supply apparatus in claim 7, wherein the uninterrupted power supply unit is pluggable.

9. The uninterrupted power supply apparatus in claim 8, wherein the power supply unit is pluggable.

10. The uninterrupted power supply apparatus in claim 9, wherein the uninterrupted power supply apparatus is arranged in a cabinet.

11. The uninterrupted power supply apparatus in claim 1, wherein when the alternating current power apparatus is not available, the load is charged by the uninterrupted power supply unit through the slot and the power distribution unit.

12. A power-supplying method for uninterrupted power supply apparatus applied to an alternating current power apparatus and a load, the power-supplying method for uninterrupted power supply apparatus comprising following steps:
a. the alternating current power apparatus sending an alternating current power to a power distribution unit, wherein the power distribution unit is electrically connected to the load, and the power distribution unit includes a plurality of slots;
b. providing a power supply unit, wherein the power supply unit is electrically connected to the power distribution unit and inserted into the corresponding slot;
c. providing an uninterrupted power supply unit, wherein the uninterrupted power supply unit is electrically connected to the power distribution unit and inserted into the corresponding slot;
d. the power distribution unit sending the alternating current power to the power supply unit through the slot;
e. the power supply unit transforming the alternating current power to a direct current power;
f. the power supply unit sending the direct current power to the power distribution unit through the slot; and
g. the power distribution unit sending the direct current power to the uninterrupted power supply unit through the slot.

13. The power-supplying method for uninterrupted power supply apparatus in claim 12, further comprising:
h. the power distribution unit sending the direct current power to the load after the direct current power is received by the power distribution unit.

14. The uninterrupted power supply apparatus in claim 13, wherein the uninterrupted power supply unit is pluggable.

15. The uninterrupted power supply apparatus in claim 14, wherein the power supply unit is pluggable.

16. The uninterrupted power supply apparatus in claim 15, wherein the power distribution unit, the power supply unit inserted into the corresponding slot, and the uninterrupted power supply unit inserted into the corresponding slot are arranged in one cabinet.

17. The power-supplying method for uninterrupted power supply apparatus in claim 12, wherein when the alternating current power apparatus is not available, the load is charged by the uninterrupted power supply unit through the slot and the power distribution unit.
